(19) United States
(12) Patent Application Publication
(10) Pub. No.: US 2014/0158099 A1
(43) Pub. Date: Jun. 12, 2014

(54) System and Method for Improved Emissions Control

(71) Applicant: BENDIX COMMERCIAL VEHICLE SYSTEMS LLC, Elyria, OH (US)

(72) Inventors: Nicholas A. ASMIS, Seven Hills, OH (US); Richard E. BEYER, Westlake, OH (US); Mark W. MCCOLLOUGH, Amherst, OH (US); Cory J. HAMILTON, Elyria, OH (US); William J. SCHAFFELD, Brecksville, OH (US)

(73) Assignee: Bendix Commercial Vehicle Systems LLC, Elyria, OH (US)

(21) Appl. No.: 13/709,416

(22) Filed: Dec. 10, 2012

(51) Int. Cl. F02M 25/07

(52) U.S. Cl. CPC F02M 25/07
USPC 123/568.15

(57) ABSTRACT

A system and method for improving exhaust gas recirculation performance is provided to induce improved exhaust gas recirculation flow during engine operating transients, including transients in which exhaust gas flow conditions are unfavorable. The apparatus includes an exhaust line including a mechatronic exhaust brake valve, an intake system including a PBS compressed air injection system, an exhaust gas recirculation passage between the exhaust and intake lines, and a controller which coordinates operation of the PBS and MEB. The controller is programmed to command the MEB to close for a period before the compressed air injection is initiated so as to build exhaust line backpressure pressure and maintain a desired pressure differential across the EGR passage so that recirculated exhaust gas flow continues to enter the intake during to PBS injection event to suppress formation of undesired excess NOₓ, particulate and other emissions.

The present invention relates to an apparatus for improving control of emissions from internal combustion engines, in particular improvement in control of NOₓ, particulate and other emissions in vehicles equipped with turbocharged diesel engines and compressed air injection systems.

### BACKGROUND OF THE INVENTION

In the field of vehicle emissions controls, it is well known that during certain operating states of the engine undesired combustion products such as oxides of nitrogen (“NOₓ”) may be minimized by introducing a portion of the exhaust gases leaving the engine's combustion chambers back into the engine's intake manifold. The recirculated exhaust gas dilutes the incoming fresh intake air, resulting in a mixture to the engine that provides two primary mechanisms for reducing NOx formation. The first mechanism is the mixture reducing the peak in-cylinder combustion temperatures where the exhaust gas acts as a heat sink. The second mechanism is the dilution of the fresh air stream, displacing some of the oxygen which would have otherwise been drawn into the combustion chamber. The lower oxygen content results in fewer constituent oxygen atoms that feed the creation of NOx and results in an overall reduction of NOx formation.

In conventional internal combustion engines, such as for example the engine 1 shown schematically in FIG. 1, an exhaust gas recirculation passage 2 is provided between an exhaust line 10 leading away from the engine's combustion chambers 3 to the engine's intake manifold 20. The exhaust gas recirculation line is often provided with a cooler 22 for cooling the portion of exhaust gas being recirculated into the intake manifold, and a flow control valve 23. The flow control valve 23 may be opened, closed and/or throttled to control the amount of exhaust gas being recirculated and thereby better match the engine's recirculated exhaust gas need to the current engine operating state. If the engine is equipped with a turbocharger 30, the exhaust gas recirculation passage 2 is typically provided downstream of the turbocharger's compressor section 31, intercooler 40 and/or any intake flow control device 50, and upstream of the turbocharger's turbine 32 and exhaust gas treatment devices 60.

A well known problem with exhaust gas recirculation systems is the tendency for recirculating exhaust gas flow from the exhaust to the intake manifold to decrease or even halt during certain engine operating conditions, i.e., when there exists an unfavorable pressure ratio between the exhaust and the intake lines, or low exhaust mass flow rate conditions are present. For example, in response to a sudden increase in engine torque demand, there may be too little exhaust gas flow available in the exhaust to supply the intake manifold with sufficient recirculated exhaust gas to match the sudden increase in oxygen and fuel being supplied to the engine's cylinders. In such situations, the lack of sufficient recirculated exhaust gas may result in an inability to adequately suppress NO formation during the transient condition, and a corresponding potential to exceed NO emissions requirements.

Previous attempts to improve exhaust gas recirculation flow primarily have concentrated on building backpressure in the downstream exhaust piping, such as by at least partially closing a downstream exhaust brake valve located upstream or downstream of the turbine side of a turbocharger, or by using a costly variable geometry turbocharger whose vanes may be adjusted to reduce flow through the turbocharger and thus build backpressure. Such approaches increase the pressure differential across the exhaust gas recirculation line between the exhaust line and the intake manifold. However, even with the assistance of such exhaust line components, adequate exhaust gas recirculation flow to the intake manifold cannot be assured in many transient engine operating conditions which occur on too short a time scale to for prior mechanical devices to adequately respond.

In view of the these and other problems in the prior art, it is an objective of the present invention to provide enhanced exhaust gas recirculation flow in all operating engine conditions, including in particular transient engine operating conditions.

This and other objectives are addressed by a system and method for real-time adjustment of fresh air induction and exhaust gas recirculation with an internal combustion engine equipped with a mechatronic exhaust brake (“MEB”), an air injection system (commonly referred to as pneumatic boost system, “PBS”) and a high speed controller which receives inputs from various sensors and/or CANbus signals, and outputs control signal for real-time coordination of MEB and PBS operations.

A mechatronic exhaust brake is an electronically actuated valve used to vary the position of a throttle flap in the exhaust line of an engine. The variable position control of the MEB flap provides the ability to vary the back pressure characteristics of the exhaust stream of an engine. The MEB in particular is a rapidly responding electro-mechanical device, including a fast-response torque motor is coupled with a controller which monitors a vehicle controller area network (“CAN”) for signals used to determine the vehicle's operating conditions.

A PBS system provides the capability of significantly enhancing the torque response of an internal combustion engine, particularly in response to an increase in torque demand at a time when the engine is operating at low speed and/or light load. In such conditions, there is a notable lag between the time the increase torque demand is made and the engine's turbocharger develops sufficient pressurized air in the fresh air intake to produce increased torque output. This is primarily due to the turbocharger being driven by exhaust gas flow, and there being a delay between the start of the increased torque demand and the build-up of a sufficient volume of exhaust gas flow to increase the rotational speed of the turbocharger (and thereby increase the fresh air intake pressure).

During transient conditions, injecting compressed air into an engine equipped with a PBS system produces a near-instantaneous increase in torque output from the engine, providing improved vehicle drivability, potential fuel savings and several other benefits. A problem with the near-instantaneous nature of PBS compressed air injection, however, is the potential a negative effect on NO emissions which primarily results from an unfavorable pressure difference across the exhaust line and the intake line. This is because the mass flow of the compressed air in a PBS event is very high, and it may take several combustion cycles before the exhaust gas flow from the engine builds up in the exhaust line. During this initial period the sudden high air pressure in the intake manifold from the PBS injection may slow or halt exhaust gas recirculation flow needed to reduce NO levels during combustion, at least until the resulting increase in exhaust gas mass flow is capable of overcoming the unfavorable pressure difference between the exhaust and the intake. The result of insufficient EGR flow during this initial period may be large increases in NOₓ formation due to lack of sufficient combustion temperature suppression by an appropriate amount of recirculated exhaust gas and increased oxygen received in the cylinder due to lack of displacement of intake air by the recirculated exhaust gas.

In the present invention, the MEB and PBS systems are provided and coordinated, preferably using a CAN bus communications network to provide favorable exhaust gas recirculation pressure conditions to maintain sufficient EGR gas flow into the intake of the engine to avoid excess NO emissions. For example, in a situation in which the PBS system determines that a compressed air injection is needed and that conditions are appropriate for such an injection, the PBS may delay initiation of the compressed air injection operation by a minimum wait time, while communicating via the CAN bus to command the MEB to move to and/or maintain a partially closed position for the duration of the wait time. The restriction provided by the MEB operation provides an increase in exhaust back pressure which assists in increasing EGR gas flow from the exhaust line to the intake line, with the timing being adapted to provide for the increased EGR gas flow to reach the intake line at approximately the moment the delayed compressed air injection is initiated. As the PBS system begins the compressed air injection, the MEB is then opened to reduce the amount of restriction (e.g., to a second partially-closed position which is more open than the first partially closed position). This partial opening of the MEB throttle flap is intended to provide an appropriate back pressure for the increase in exhaust gas flow which results immediately upon the injection of compressed air from the PBS system into the engine's cylinders. Preferably, the rate by which the MEB is moved from the first partially opened position to the second partially opened position may be varied (for example, based on changing engine conditions) to more closely match the desired EGR flow from the exhaust line to the intake line to the actual requirements of the engine. As the PBS completes the compressed air injection event, the MEB may be moved back to a more fully opened position commensurate with the engine's current operating state. The amount of MEB throttle flap opening may also be controlled based on other parameters, such as control to maintain a desired differential pressure or differential pressure profile across the EGR line between the exhaust and intake lines.

Alternatively, rather than separate control electronics for the PBS and MEB systems, the functions of these control systems may be integrated into a single module.

The present invention thus provides a highly rapid and responsive interactive system for controlling exhaust back pressure in coordination with compressed air injection events to more precisely maintain accurate control of NO emissions by providing a favorable pressure difference across an exhaust gas recirculation system during virtually any engine operating condition. Moreover, because the use of a PBS system may reduce the length of a transient event (for example, by increasing engine torque output enough that the engine reaches a more efficient operating point and the vehicle reaches a desired speed more quickly), the total NOₓ emissions potentially produced during a given drive cycle may be smaller than that of a non-PBS-, non-MEB-equipped engine.

Further synergistic benefits may also be obtained with the present invention. For example, the emissions control accuracy provided by the coordinated system provides the ability to design a vehicle powertrain which, as a result of the superior emissions performance, may dispense with undesirable costly and maintenance-intensive exhaust gas after-treatment equipment and related control systems. This in turn offers further savings in vehicle weight and enhanced fuel efficiency. For example, the present invention may enable a vehicle to provide emissions performance to meet increasingly stringent government emissions requirements at levels as low as 0.2 g/bhp*hr without the need to include selective catalytic reduction (“SCR”) equipment on the vehicle. The invention may also eliminate any need to resort to costly variable-geometry turbochargers.

The control of the MEB throttle flap, including flap position, opening timing and ramp rate (i.e., the rate at which the flap is moved, either linear or higher-order curve) need not be directly from the PBS system. For example, in an alternative embodiment of the present invention the MEB control may be based on the engine ECU using inputs such as accelerator pedal position or torque requests to initiate operation. This approach has an advantage of direct connectivity to the engine.

It should be understood that the coordinated timing of build-up of exhaust back pressure of the present invention does not require a particular form of MEB valve, and may be implemented with a sufficiently responsive exhaust valve or similar back pressure device controlled in response to a preset or lookup-table-governed position(s) based on initial operating parameters.

In a further embodiment of the present invention, the system may provide for response to engine transients which may generate an unfavorable exhaust line-to-intake line pressure difference by activating the exhaust back pressure control device quickly enough to maintain EGR flow, independent of whether a PBS compressed air injection event is initiated or whether the vehicle is equipped with a PBS system. Thus, the present invention's improved emissions performance may permit development of emissions-compliant engines for markets in which only PBS=equipped engines were believed to be suitable.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a previously known turbocharged engine with an exhaust gas recirculation passage.

FIG. 2 is a schematic illustration of an exhaust gas recirculation system arrangement in accordance with an embodiment of the present invention.

FIG. 3 is a flow chart illustrating an example operating logic for the exhaust gas recirculation system arrangement of FIG. 2.

FIG. 4 is a graph illustrating a typical operation of the MEB during the operations illustrated in the FIG. 3 flow chart.

FIG. 5 is a graph illustrating the typical effects on exhaust gas flows during the coordinated operation of the MEB and PBS system during the operations illustrated in the FIG. 3 flow chart.

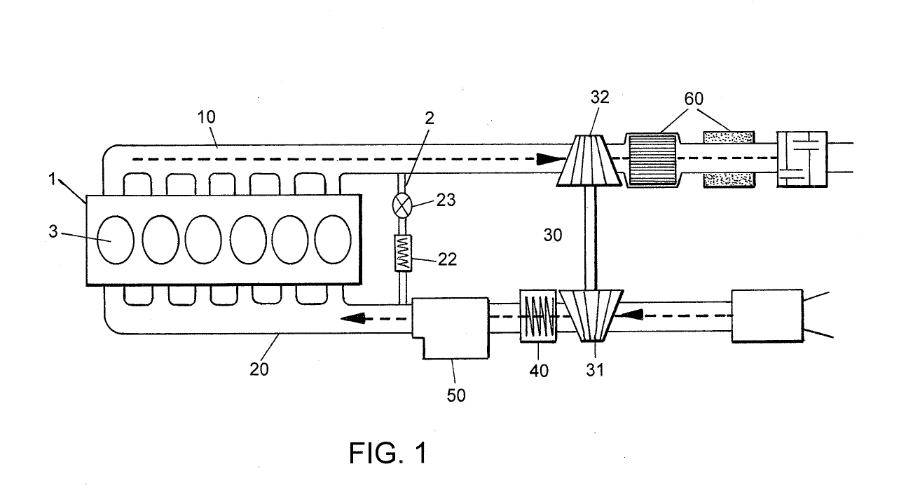

### DETAILED DESCRIPTION

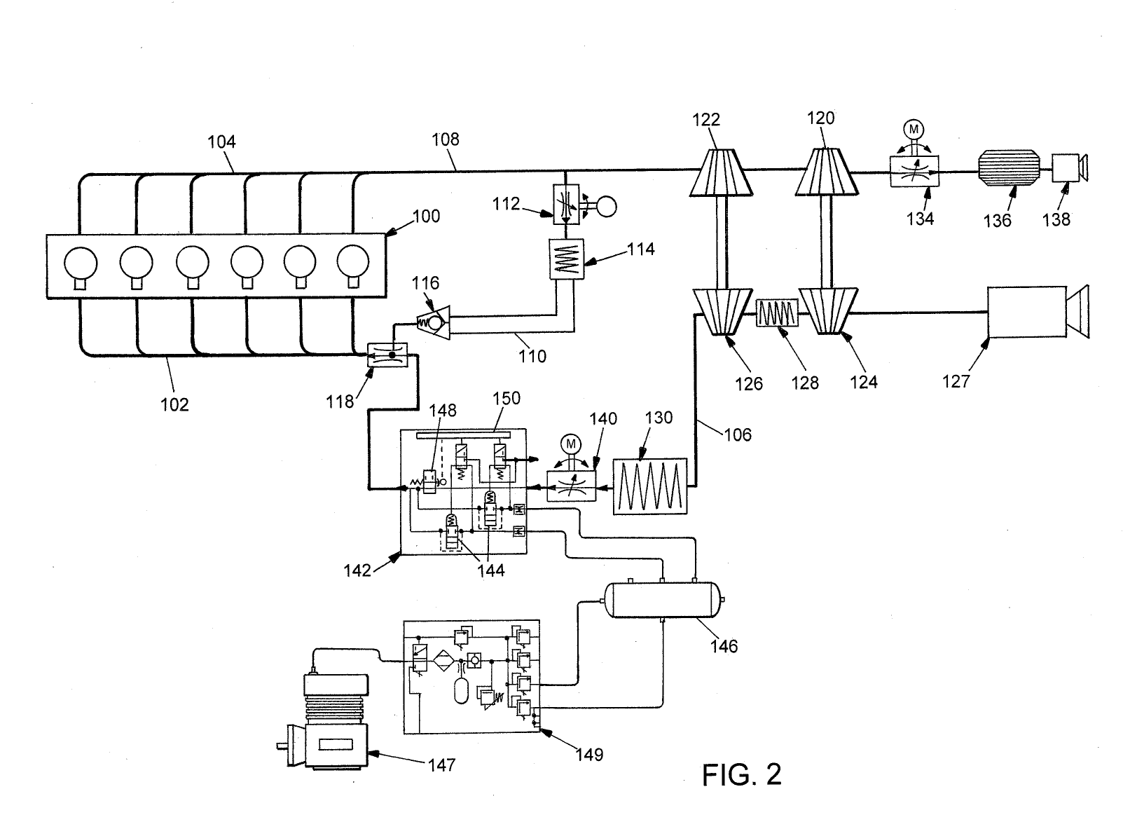

FIG. 2 is a schematic illustration of an embodiment of the present invention, in which engine 100 is provided with a fresh air intake manifold 102 which receives air for combustion in the engine cylinders from an upstream intake line 106, and an exhaust manifold 104 which conveys combustion exhaust gases from the engine cylinders to exhaust line 108.

Extending between the exhaust line 108 and the intake line 106 is an exhaust gas recirculation path 110. The exhaust gas recirculation path includes an EGR throttle valve 112 which may be set to control the rate of EGR flow from the exhaust line 108 to the intake line 106. The exhaust gas recirculation path 110 also includes an EGR heat exchanger 114 provided to cool the recirculating exhaust gas, A back-flow-prevention check valve 116 may also be provided. The exhaust gas recirculation path 110 conveys recirculating exhaust gases to the intake line 106 via an EGR injection point 118, in this embodiment a venturi arrangement which employs acceleration of the fresh air intake flow to assist in extracting exhaust gas from the recirculation path 110. Preferably, the EGR injection point 118 is in the form of a venturi configured to make use of the Coand\check{a} effect to enhance the exhaust gas flow, as described in U.S. patent application Ser. No. ______.

The exhaust line 108 also includes the exhaust gas-driven turbines of a first stage turbocharger 120 and a second stage turbocharger 122. The turbines drive corresponding compressor wheels 124, 126 to sequentially increase the pressure and mass flow rate of the fresh air being delivered via intake line 106 from intake air filter 127 to the engine 100. Between the turbocharger compressor stages is a first fresh air heat exchanger 128 which removes heat from the air compressed by the first compressor wheel 124. A second fresh air heat exchanger 130 (also known as a “charge air cooler)” is located downstream of the second compressor wheel 126 to further remove heat from the air compressed by turbochargers.

The exhaust line 108 further includes an MEB 134 downstream of the first turbine 120. The electronics of MEB 134 communicate with other electronics of the vehicle via a CAN bus network. Because CAN bus technology is well known, the details of the CAN bus connections are not further illustrated. After passing through the MEB 134, the exhaust gases pass through a particulate filter 136 which removes particulate combustion byproduct particles from the exhaust flow, followed by passing through an exhaust stack 138 to reach the atmosphere.

Between the second intake air heat exchanger 130 and the EGR injection point 118 is an intake air throttle valve assembly 140 and a PBS compressed air injection module 142. Alternatively, if the PBS module is capable of handling the throttle valve assembly's functions, the throttle valve assembly 140 may be omitted. In this embodiment the PBS module 142 includes a plurality of rapid-acting solenoid valves 144 which control the flow of compressed air from reservoir 146 into the intake line 106 (the reservoir 146 being supplied with compressed air from compressor 147 and air drier unit 149). The compressed air is injected into intake line 106 downstream from flow control valve 148, which is closed in conjunction with the compressed air injection during a PBS event in order to prevent backflow of compressed air upstream of PBS module 142. The operation of the PBS system is controlled by electronics unit 150, in this embodiment integrated into the PBS module 142 and connected to the vehicle's CAN bus to communicate with other modules, including the control electronics for the MEB 134.

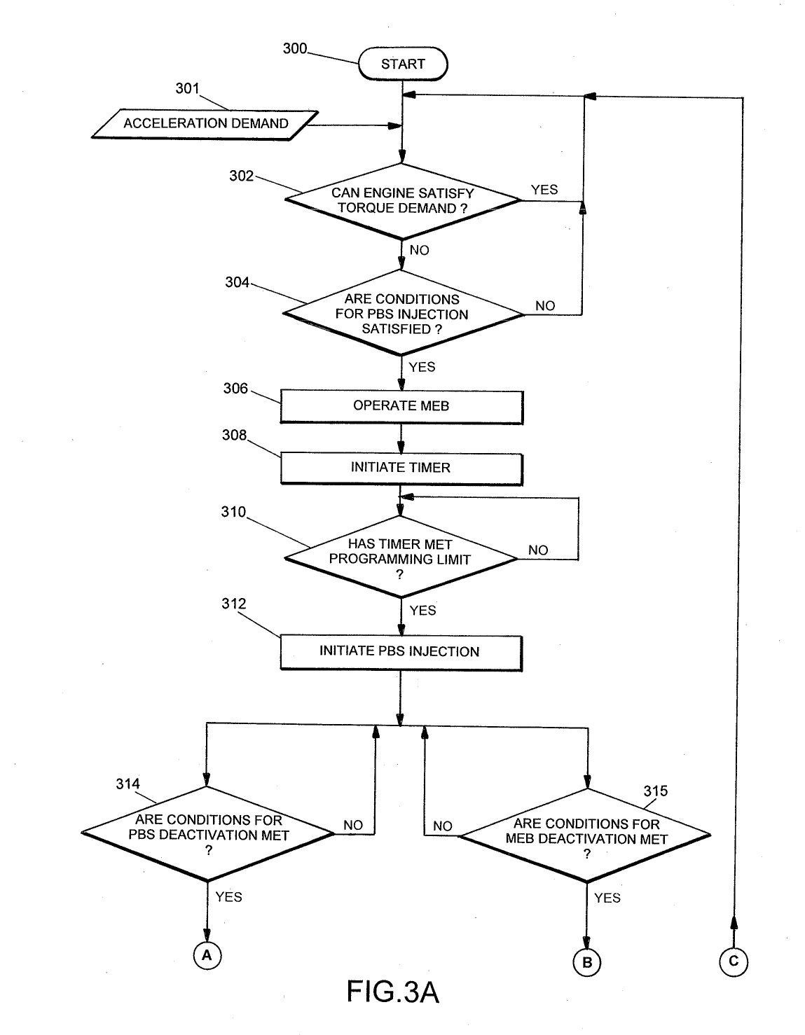

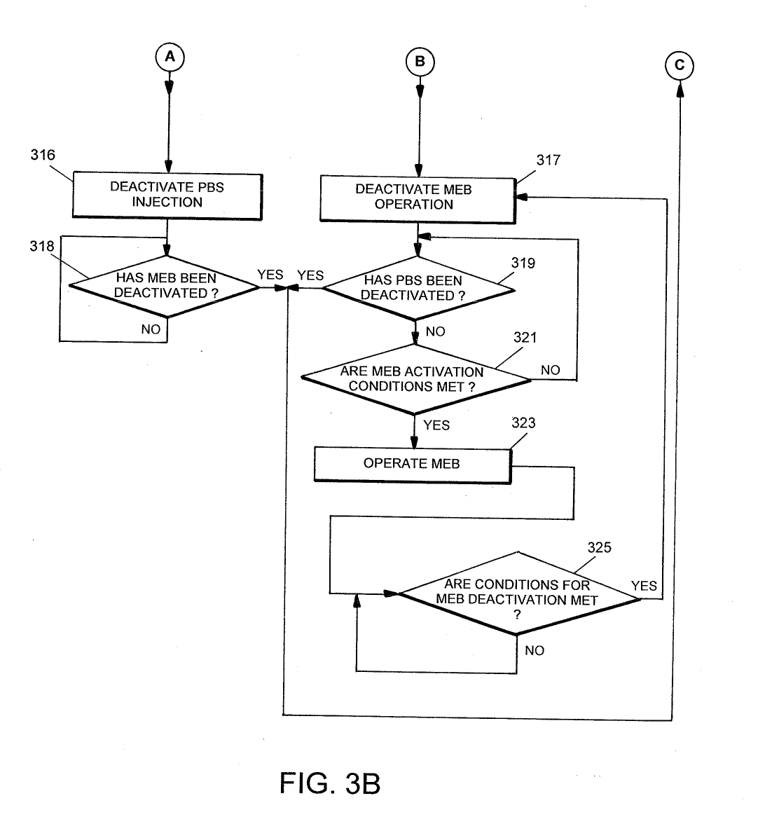

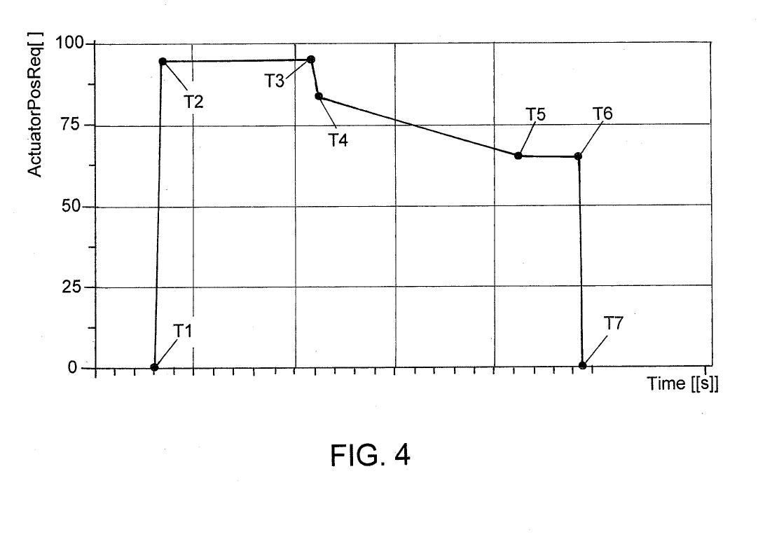

An example operation of the above embodiment is described with the aid of the flow chart shown in FIG. 3 and the FIGS. 4-6 graphs illustrating system responses.

The operating logic shown in FIG. 3 begins at the start point 300. At step 302 the system electronics (whether embodied in a stand-alone controller module or a combined module, such as a combined engine, PBS and MEB electronic control unit (“ECU”)) determines whether the present acceleration demand can be satisfied by the engine, without the assistance of a PBS compressed air injection event. The acceleration demand may be inputted to the system via input 301 from a demand source, such as a signal from a physical sensor such as a throttle pedal position sensor, or a signal from an electronic control module which has calculated a target acceleration demand (i.e., an engine torque output demand) based on evaluation of vehicle sensors and operating conditions such as engine speed, road speed, intake and/or exhaust manifold pressure and/or temperature, transmission state, stored compressed air amount, exhaust treatment device operating state (e.g., whether in regeneration mode), and/or anticipated road conditions derived from GPS position data. If no PBS injection is deemed needed (“yes”) control is returned to the beginning of the program logic.

If the system electronics determines that the engine will not be able to meet the present torque demand without the assistance of a PBS injection event (“no”) control shifts to step 304. In step 304 the system electronics determine, based on vehicle sensor and other inputs, whether the prerequisite conditions for executing a PBS injection are met (for example, determining there is sufficient compressed air in the reservoir 146 to conduct the anticipated compressed air injection while maintaining a sufficient reserve of compressed air to operate essential compressed air consumers on the vehicle, such as pneumatic brake actuators). If the PBS injection conditions are not met (“no”) control is returned to the beginning of the program logic. If the PBS injection prerequisite conditions are met (“yes”) control shifts to step 306.

In step 306 the system electronics initiates operation of the mechantronic exhaust brake 134 to position the MEB's throttle flap to a position which results in generation of increased back pressure upstream in the exhaust line 108. The rate at which the throttle flap is moved into the desired position and the target angular position of the flap may be determined from vehicle operating parameters in order to match the pressure back pressure level and the timing of the arrival of the back pressure at the EGR line 110 to achieve a desired exhaust gas recirculation mass flow rate at the intake injection point 118 when PBS compressed air injection is initiated. This tailoring of the position, angular velocity and/or acceleration curve of the MEB throttle flap to the projected PBS flow provides an increase in EGR flow at or near exactly the correct timing to highly accurately matched EGR flow to the increased intake air flow arriving at the engine's cylinders when the PBS injection is initiated. This highly accurate matching helps to maintain a desired minimal level of NOx emissions. The amount of increase in EGR flow may be managed to maintain a desired differential pressure across the EGR line, or by other approaches, such as maintaining a desired differential pressure across the MEB.

The MEB throttle flap's position, angular velocity and/or acceleration curve may be determined by any of the associated system electronics, including at the MEB electronics, at the PBS electronics, or in a combination ECU. The throttle flap's position, angular velocity and/or acceleration curve may be determined by a variety of techniques, including by reference to a look-up table defining flap movement as a function of vehicle operating parameter such as engine rpm, current exhaust gas flow rate in exhaust line 108, differential pressure between the exhaust line 108 and the intake line 106, etc. Alternatively, the throttle flap movement may be determined in accordance with calculations implementing flow control equations in the system logic, either in the MEB electronics or elsewhere, based on vehicle sensor signals and/or vehicle component operating states. During the time the MEB is activated, the position of the MEB's throttle flap may be varied as needed to any intermediate position between fully closed and fully open so as to refine its restriction of exhaust gas flow, and hence the exhaust line backpressure, to provide optimal upstream conditions during a PBS injection event. For example, rather than being held in a fixed partially closed position, the MEB throttle flap may be adaptively opened or closed as necessary to maintain a desired differential pressure across the exhaust gas recirculation path 110 between the exhaust line 108 and the intake line 106. Alternatively, the MEB throttle flap position may be varied to obtain a desired recirculating exhaust gas mass flow rate or to increase or decrease the EGR mass flow rate to match intake operating parameters.

Immediately following the signaling in step 306 for the MEB 134 to move its throttle flap to increase exhaust line 108 back pressure, in step 308 a timer is started. In step 310 the timer counts until a desired delay period between the operation of the MEB 134 and the initiation of PBS injection pulses. The desired delay period may be fixed, or may be variable to accommodate different vehicle operating states and/or operating conditions. When the timer has reached the end of the programmed time (“yes” in step 310), the control logic advances to step 312. A typical desired delay period may be on the order of 200-400 milliseconds, but also may be very short, for example, 50 milliseconds.

The PBS compressed air injection is commanded to be initiated in step 312 following the delay period. Essentially simultaneously, within the PBS module 142 the PBS electronics 150 commands at least one of the compressed air injection flow control valves 144 to open, while intake line backflow prevention valve 148 is closed to prevent backflow of compressed air upstream toward the turbochargers. The backflow prevention valve 148 typically remains closed at least until the increased exhaust gas flow in exhaust line 108 resulting from the PBS injection accelerates the turbocharger compressor wheels 124, 126 enough to build sufficient pressure in intake line 106 to “take over” supply of fresh air to the engine from the PBS injection system.

Following the initiation of the PBS compressed air injection in step 312, the control logic proceeds along two paths in parallel.

In the path shown on the left side of the lower portion of FIG. 3, in step 314 the system electronics determine whether the conditions for discontinuing PBS injection have been met, for example, reaching the end of the desired duration of compressed air injection, or the identification of a parameter which requires PBS injection terminations such as reaching a compressed air reservoir 146 low pressure limit. If the PBS injection termination conditions have not been met (“no”) the control in this parallel branch repeatedly returns to step 312 until the termination conditions are met (“yes”).

Once the conditions for deactivating the PBS system to discontinue compressed air injection have been met, the control logic shifts to step 316, whereby the control electronics command deactivation of the PBS injection. This is followed in step 318 by a determination as to whether the MEB 134 had been deactivated (i.e., the MEB throttle flap has been moved to a position which results in a decrease in throttle flap-generated exhaust backpressure). If the MEB 134 has not been deactivated (“no”) control in this branch repeatedly returns to step 318 until the MEB has been deactivated (“yes”).

In parallel with the PBS injection deactivation steps, in step 315 the system electronics determines whether the conditions for repositioning the MEB 134 have been met, for example, upon the build-up of sufficient exhaust gas flow in exhaust line 108 as a result of the PBS compressed air injection to build sufficient pressure to drive sufficient exhaust gas recirculation flow into the intake without the flow restriction of the MEB throttle flap. If the MEB deactivation conditions have not been met (“no”) the control in this second parallel branch repeatedly returns to step 315 until the termination conditions are met (“yes”).

Once the conditions for MEB deactivation have been met, the control logic shifts to step 317, whereby the control electronics command the MEB throttle flap to move to the next desired position. Next, in step 319 the system electronics check to see whether the PBS injection is still active, i.e., a determination is made as to whether the PBS injection has been deactivated. If the PBS injection system has not been deactivated (“no”), in step 321 the system electronics determines whether the MEB should be reactivated by determining whether, with the PBS injection still ongoing, the conditions for re-activating the MEB are present. If the MEB activation conditions are not present, this branch of the control logic repeatedly returns to step 319 until either the PBS system has been deactivated (“yes” in step 319) or the conditions for reactivating the MEB have been met (“yes” in step 321). If the conditions for reactivating the MEB are present at step 321, in step 323 the MEB is activated by operating the throttle flap to increase backpressure in the exhaust line 108.

Following reactivation of the MEB the control logic shifts to step 325, wherein the system electronics determines whether the MEB should again be deactivated. If the MEB deactivation conditions do not exist, the control logic (“no”) repeatedly returns to step 325. If the system electronics determine the MEB deactivation conditions do exist, the control logic returns to step 317, whereupon the system electronics again command deactivation of the MEB, and then again assesses whether the PBS injection has been terminated in step 319.

Once both the PBS injection and the MEB have been deactivated (“yes” to either step 318 or step 319), the control logic returns to the beginning of the control algorithm.

FIG. 4 provides an example of a typical response of the MEB during the operations illustrated in the FIG. 3 flow chart. At time T1 the MEB initiates movement of its throttle flap (step 306). Because of the extremely high speed of the mechatronic exhaust valve unit, within approximately 100 milliseconds the throttle flap has reached a position more than 90% closed at time T2. After an initial period T2-T3 during which the MEB throttle flap is maintained at its initial partially closed position (for example, on the order of 200-500 milliseconds), at time T3 the MEB is commanded to reduce the degree of restriction (i.e., degree of MEB closure), in this example to maintain a desired amount of pressure difference across the EGR path 110. After a reaction time of approximately 100 milliseconds, the throttle flap reaches a second slightly more open position at time T4 and begins a controlled opening period at a rate of approximately 0.1% of closure per millisecond until reaching a desired degree of opening at time T5. The decay rate of the opening is coordinated with the PBS injection to ensure the pressure in the exhaust line 108 remains higher than in intake line 106 in order to maintain a favorable pressure distribution for exhaust gas recirculation over the course of the PBS event.

Over the course of approximately 250-440 milliseconds between times T4 and T5, the throttle flap reaches the desired degree of restriction (in this embodiment, a degree of opening of approximately 65%), where the flap is held until time T6. In coordination with the termination of PBS injection and at a time at which a favorable EGR pressure differential can be self-maintained, the system electronics at time T6 command the MEB throttle flap to the full open position (step 317), which it reaches at time T7 in approximately 10 milliseconds.

The position of the MEB throttle flap may be controlled in a manner different than above-described pattern of “closed to steep angle and gradually opened. For example, after the initial closure of the valve, subsequent throttle flap opening position commands may either further close the throttle flap, momentarily open the throttle flap a certain amount then move the throttle flap back in the closed position. Other alternative throttle flap movement patterns may include a ramped or stair-stepped movement from an open position toward a closed position to provide a slower back pressure increase rate, a simple “close-then-open” sequence (i.e., a square-wave pattern), or a closure and opening pattern which follows variations in system input parameters to “follow” variable back-pressure demands during transient engine operating conditions. The MEB throttle flap control patterns may also be adapted to individual engine and/or vehicle configurations as needed.

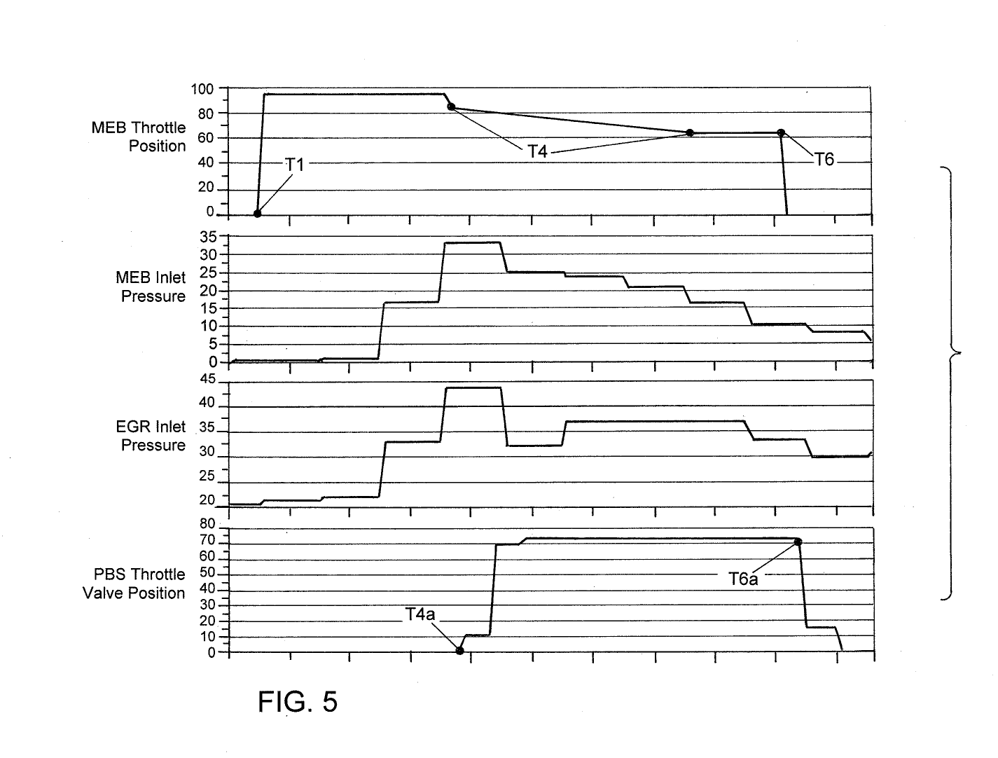

FIG. 5 provides an example of a typical operational responses occurring during the PBS injection event, along with illustration of the actuation of the PBS system and the MEB during the operations illustrated in the FIG. 3 flow chart.

The first of the four graphs in FIG. 5 correspond to the MEB throttle flap actuation pattern shown in FIG. 4. The bottom-most graph illustrates the PBS system's compressed air injection pattern. The two center graphs respectively illustrate the exhaust gas pressure immediately upstream of the MEB in the exhaust line 108, and the exhaust gas pressure at the point of entry of exhaust gas from exhaust line 108 to EGR path 110.

As noted in the discussion of FIGS. 3 and 4, upon determining in step 302 that the engine will need assistance in meeting the torque demand, at time T1 the MEB throttle flap is commanded to a first position. After a brief delay (approximately 250-450 milliseconds) to allow build-up of sufficient exhaust gas pressure in the exhaust line 108 upstream of the MEB throttle flap and at the inlet to the EGR passage 110 (corresponding to points T2a and T2b on the second and third FIG. 5 graphs, respectively), the PBS system at time T4a initiates compressed air injection into the intake line 106, approximately simultaneously with the beginning of the gradual opening of the MEB throttle flap.

Due to the influence of the high pressure compressed air injected by the PBS system, the exhaust gas pressure in exhaust line 108 at the entrance to the EGR passage 110 will immediately begin to rise, potentially resulting in an over-pressure condition unless the MEB throttle flap begins to open to increase the exhaust gas flow rate. As shown in the second graph in FIG. 5, the exhaust gas pressure at the MEB thus follows the gradual opening of the throttle flap between times T4 and T5. The objective is to maintain a relatively constant exhaust gas pressure gradient at the entrance to the EGR passage 110 by balancing the increased exhaust gas flow from the PBS compressed air injection with the decreasing restriction of the exhaust line by the MEB throttle flap. The relatively constant EGR inlet pressure gradient results in a relatively constant recirculating EGR exhaust gas mass flow rate which is well matched to the intake air mass flow rate from essentially the beginning of the transient engine operation, avoiding EGR-deprived combustion cycles which can generate undesired excessive NOₓ emissions. This relatively constant EGR inlet pressure gradient effect is visible in the latter portion of the third FIG. 5 graph.

The system electronics at time T6 command the MEB throttle flap to fully re-open, followed very shortly thereafter at time T6a commanding the PBS compressed air injection control valves to close. By this time, the increased exhaust gas flow has caused the turbocharger compressors to increase speed to the point that the turbochargers are supplying sufficient pressure in intake line 106 to sustain the engine's increased output in response to the torque demand, and therefore the pressure in the exhaust line 108 at the inlet to the EGR passage 110 remains relatively stable following the termination of PBS injection.

Alternative embodiments of the present invention may use a variable-geometry turbine on a turbine side of a turbocharger to assist in varying back pressure. Similarly, and exhaust throttling device may be located upstream or downstream of a turbocharger or, in the presence of more than one turbocharger, between turbochargers.

The foregoing disclosure has been set forth merely to illustrate the invention and is not intended to be limiting. Because such modifications of the disclosed embodiments incorporating the spirit and substance of the invention may occur to persons skilled in the art, the invention should be construed to include everything within the scope of the appended claims and equivalents thereof.

What is claimed is:

1. A system for controlling exhaust gas recirculation for an internal combustion engine, comprising:
a fresh air intake line of the engine including a fresh air flow control valve;
an exhaust line of the engine including a mechatronic exhaust brake valve;
an exhaust gas recirculation conduit arranged to conduct exhaust gas between the exhaust line upstream of the mechatronic exhaust brake valve and the fresh air intake line downstream of the fresh air flow control valve;
a compressed air injection system including at least one compressed air injection flow control valve arranged to inject compressed air into the fresh air intake line downstream of the fresh air flow control valve; and
at least one control module configured to control the mechatronic exhaust brake valve and the at least one compressed air injection flow control valve in response to an engine torque output demand to maintain a pressure difference across the exhaust gas recirculation conduit sufficient to maintain exhaust gas recirculation flow from the exhaust line into the intake line during a compressed air injection event.

2. The system of claim 1, wherein
the at least one control module is configured to command the compressed air injection flow control valve to open to initiate compressed air injection after a time delay following issuance of a command to set the mechatronic exhaust brake valve to a first position.

3. The system of claim 2, wherein
after commanding the mechatronic exhaust brake valve to the first position the at least one control module is configured to command the mechatronic exhaust brake valve to at least a second position to permit increasing exhaust gas flow through the mechatronic exhaust brake valve while maintaining exhaust gas flow across the exhaust gas recirculation conduit from the exhaust line into the intake line as pressures in the fresh air intake line and the exhaust line change during the compressed air injection event.

4. The system of claim 3, wherein
the at least one control module is configured to command the mechatronic exhaust brake valve to at least one second position, followed by further opening of the mechatronic exhaust brake valve in an opening pattern in which a degree of opening of the mechatronic exhaust brake valve increases over time while maintaining the pressure difference across the exhaust gas recirculation conduit sufficient to maintain exhaust gas recirculation flow from the exhaust line into the intake line during a compressed air injection event.

5. The system of claim 2, wherein
the at least one control module is configured to receive signals from at least one other control module and at least one vehicle sensor and to command the mechatronic exhaust brake valve position based on the received signals.

6. The system of claim 2, wherein
the at least one control module is configured to receive signals from at least one other control module and at least one vehicle signal and to set the time delay between mechatronic exhaust brake valve positioning and opening of the at least one compressed air injection valve based on the received signals.

7. The system of claim 6, wherein
the at least one control module is configured to determine at least one of mechatronic exhaust brake valve positioning and the time delay for opening of the at least one compressed air injection valve by reference to a stored look-up table.

8. The system of claim 6, wherein
the received signals are generated by at least one of pressure sensors, temperature sensors and gas mass flow sensors.

9. The system of claim 6, wherein
after commanding the mechatronic exhaust brake valve to the first position the at least one control module is configured to command the mechatronic exhaust brake valve to move in a closing direction at a rate which maintains exhaust gas flow across the exhaust gas recirculation conduit from the exhaust line into the intake line as pressures in the fresh air intake line and the exhaust line change during the compressed air injection event.

10. The system of claim 9, wherein
the at least one control module is configured to command the mechatronic exhaust brake valve to move in the closing direction at a constant rate over at least a portion of the compressed air injection event.

11. A method of controlling operation of an engine equipped with a mechatronic exhaust brake valve, a compressed air injection system including at least one compressed air injection flow control valve and a control module configured to control actuation of the mechatronic exhaust brake valve and the compressed air injection system, comprising the acts of:
receiving a signal at the control module corresponding to an engine torque output demand;
determining whether to initiate a compressed air injection event to meet the engine torque output demand;
issuing a signal from the control module to close the mechatronic exhaust brake valve to a first position to inhibit exhaust gas flow; and
issuing a signal from the control module to the compressed air injection system to initiate compressed air injection into an intake line of the engine after a time delay calculated to maintain a pressure difference across an exhaust gas recirculation conduit sufficient to maintain exhaust gas recirculation flow from the exhaust line into the intake line during a compressed air injection event.

12. The method of claim 11, further comprising the act of:
after the act of issuing the signal to close the mechatronic exhaust brake valve to the first position, issuing a valve opening signal to open the mechatronic exhaust brake valve to at least a second position to permit increasing exhaust gas flow through the mechatronic exhaust brake valve while maintaining exhaust gas flow across the exhaust gas recirculation conduit from the exhaust line into the intake line as pressures in the fresh air intake line and the exhaust line change during the compressed air injection event.

13. The method of claim 12, wherein the time delay is determined by reference to a stored look-up table using said vehicle operating parameters.

14. The method of claim 12, wherein the time delay is calculated using said vehicle operating parameters such that an exhaust gas pressure at an inlet of the exhaust gas recirculation conduit is higher than a fresh air gas pressure at an outlet of the exhaust gas recirculation conduit when the compressed air injection system initiates compressed air injection.

15. The method of claim 14, wherein
the act of issuing a valve opening signal to open the mechatronic exhaust brake valve to at least a second position includes commanding the mechatronic exhaust brake valve to move in a closing direction at a rate which maintains exhaust gas flow across the exhaust gas recirculation conduit from the exhaust line into the intake line as pressures in the fresh air intake line and the exhaust line change during the compressed air injection event.

16. The method of claim 15, wherein
the vehicle operating parameters are received from at least one of pressure sensors, temperature sensors, gas mass flow sensors and other control modules.

17. A control module for controlling a mechatronic exhaust brake valve and a compressed air injection system to maintain exhaust gas recirculation flow to an intake line of an engine during a compressed air injection event, comprising:
an electronic unit configured to receive signals corresponding to vehicle operating parameters and issue signals commanding actuation of the mechatronic exhaust brake valve and the compressed air injection system,
wherein the electronic unit is programmed to issue a signal to the compressed air injection system to initiate compressed air injection into the intake line after a time delay following issuance of a signal to move the mechatronic exhaust brake valve to a first position, the time delay selected by the electronic unit is sufficient to maintain a pressure difference across an exhaust gas recirculation conduit between and exhaust line of the engine and the intake line sufficient to maintain exhaust gas recirculation flow into the intake line during a compressed air injection event.

18. A control module for controlling a mechatronic exhaust brake valve and a compressed air injection system to maintain exhaust gas recirculation flow during a compressed air injection event, comprising:
an electronic unit configured to receive signals corresponding to vehicle operating parameters and issue signals commanding actuation of the mechatronic exhaust brake valve and the compressed air injection system,
wherein
at least one of the signals corresponding to vehicle operating parameters is an engine torque output demand, and
the electronic control is programmed to
determine whether a compressed air injection event is needed to meet the engine torque output demand, and
if a compressed air injection event is needed to meet the engine torque output demand, issue a signal to the compressed air injection system to initiate compressed air injection into an intake line of the engine after a time delay following issuance of a signal to move the mechatronic exhaust brake valve to a first position, the electronic control being programmed to select a length of the time delay sufficient to maintain a pressure difference across an exhaust gas recirculation conduit sufficient to maintain exhaust gas recirculation flow from the exhaust line into the intake line during a compressed air injection event.

19. The control module of claim 18, further wherein
the electronic unit is programmed to issue a signal to the mechatronic exhaust brake valve to move from the first position to at least a second position to permit increasing exhaust gas flow through the mechatronic exhaust brake valve while maintaining exhaust gas flow across the exhaust gas recirculation conduit from the exhaust line into the intake line as pressures in the fresh air intake line and the exhaust line change during the compressed air injection event.

20. A system for controlling exhaust gas recirculation for an internal combustion engine, comprising:
a fresh air intake line of the engine including a fresh air flow control valve;
an exhaust line of the engine including a mechatronic exhaust brake valve;
an exhaust gas recirculation conduit arranged to conduct exhaust gas between the exhaust line upstream of the mechatronic exhaust brake valve and the fresh air intake line downstream of the fresh air flow control valve;
a compressed air injection system including at least one compressed air injection flow control valve arranged to injected compressed air into the fresh air intake line downstream of the fresh air flow control valve; and
at least one control module configured to control the mechatronic exhaust brake valve and the at least one compressed air injection flow control valve in response to an engine torque output demand to maintain a pressure difference across the exhaust gas recirculation conduit sufficient to maintain exhaust gas recirculation flow from the exhaust line into the intake line during a compressed air injection event,
wherein
the at least one control module is configured to command the compressed air injection flow control valve to open to initiate compressed air injection after a time delay following issuance of a command to set the mechatronic exhaust brake valve to a first position,
the first position of the mechatronic exhaust brake valve is set to obtain a pre-determined differential pressure across the exhaust gas recirculation conduit between the exhaust line and the fresh air intake line, and
the time delay before opening the compressed air injection flow control valve is between 0.05 seconds and 0.5 seconds.

21. The system of claim 20, wherein
the first position of the mechatronic exhaust brake valve is between 75% and 100% closed

22. The system of claim 20, wherein
after commanding the mechatronic exhaust brake valve to the first position the at least one control module is configured to command the mechatronic exhaust brake valve to at least a second position more open than the first position.

23. The system of claim 20, wherein
the at least one control module is configured to command the mechatronic exhaust brake valve to at least one second position, followed by further opening of the mechatronic exhaust brake valve in an opening pattern in which a degree of opening of the mechatronic exhaust brake valve increases over time while maintain the pressure difference across the exhaust gas recirculation conduit sufficient to maintain exhaust gas recirculation flow from the exhaust line into the intake line during a compressed air injection event.
